(19) United States
(12) Patent Application Publication
(10) Pub. No.: US 2020/0307631 A1
(43) Pub. Date: Oct. 1, 2020

(54) VEHICLE CONTROL SYSTEM

(71) Applicant: HONDA MOTOR CO., LTD., Tokyo (JP)

(72) Inventors: Kanta TSUJI, Wako-shi (JP); Tadashi NARUSE, Wako-shi (JP); Daichi KATO, Wako-shi (JP)

(21) Appl. No.: 16/832,705

(22) Filed: Mar. 27, 2020

(30) Foreign Application Priority Data
Mar. 29, 2019 (JP) 2019067652

(51) Int. Cl. B60W 60/00; B60W 10/20; B60W 30/18; B60W 10/188; B60W 10/30; B60W 10/10

(52) U.S. Cl. CPC B60W 60/0016; B60W 10/20; B60W 30/181; B60W 2540/26; B60W 10/188; B60W 10/30; B60W 10/10; B60W 60/0059

(57) ABSTRACT

In a vehicle control system (1, 101, 201) configured for autonomous driving, a control unit executes a stop process by which the vehicle is parked in a prescribed stop area when it is detected that the control unit or a driver has become incapable of properly maintaining a traveling state of the vehicle, and a stop maintaining process for keeping the vehicle parked following the vehicle coming to a stop in the stop process. The control unit keeps the brake lamp turned on while the stop maintaining process is being executed.

### TECHNICAL FIELD

The present invention relates to a vehicle control system configured for autonomous driving.

### BACKGROUND ART

According to a known vehicle control system for a shift by wire vehicle, when the shift lever is shifted to the parking position, the hydraulic brake is activated at the same time as setting the transmission range to the parking range. See JP2018-138449A, for instance. In an emergency situation such as when the driver has become unconscious, this prior art allows a passenger (who may be a fellow passenger or the driver) to activate the hydraulic brake by operating the shift level which can be more readily operated by the passenger than the brake pedal so that the vehicle can be brought to a stop with a minimum delay.

According to this prior art, the vehicle may come to a stop relatively promptly, but no consideration is made regarding the selection of the position at which the vehicle comes to a stop. If the vehicle comes to a stop in a part of the road which is not visible from approaching vehicles, the vehicle that is brought to a stop in such a place may create a hazardous condition for other vehicles. To overcome such a problem, it has been proposed to use an autonomous driving vehicle which, in an emergency situation, can execute a stop process whereby a relatively safe stop area is determined, and the vehicle is autonomously driven to the stop area to be parked therein.

Once the vehicle has come to a stop, the shift position is shifted to the parking position, and the parking brake is engaged while the hydraulic brake is released. As a result, the brake lamp is turned off as soon as the vehicle comes to a stop in the stop area. Therefore, the visibility of the vehicle which has come to a stop to approaching vehicles may be low so that there is a risk that the approaching vehicle may fail to properly avoid the parked vehicle.

On the other hand, it is not desirable to keep the hydraulic brake engaged while the vehicle is parked in the emergency situation since the pump for actuating the hydraulic brake is required to be kept in operation while the vehicle is parked, and this involves a significant consumption of electric power. Therefore, if the vehicle is kept parked for a long period of time, the onboard battery may run out, and this not only prevents the brake lamp to be kept turned on, but may also cause an inconvenience for the subsequent rescue effort.

### SUMMARY OF THE INVENTION

In view of such a problem of the prior art, a primary object of the present invention is to provide a vehicle control system configured for autonomous driving which can keep the brake lamp turned on for a long period of time when the vehicle is parked in a stop area as a result of a stop process.

To achieve such an object, the present invention provides a vehicle control system (1, 101, 201) configured for autonomous driving, comprising: a control unit (15) for steering, accelerating, and decelerating a vehicle; a brake device (4) for applying a brake force to the vehicle; and a brake lamp (14a); wherein the control unit is configured to execute a stop process by which the vehicle is parked in a prescribed stop area when it is detected that the control unit or a driver has become incapable of properly maintaining a traveling state of the vehicle, and a stop maintaining process for keeping the vehicle parked following the vehicle coming to a stop in the stop process, the control unit keeping the brake lamp turned on while the stop maintaining process is being executed.

Since the brake lamp is turned on when the vehicle is parked in the stop area, the visibility of the vehicle to approaching vehicles can be increased so that the risk of an accident can be minimized.

Preferably, the brake device includes a hydraulic circuit (99), a brake force applying device (84) for applying a brake force to a wheel of the vehicle in response to a hydraulic pressure in the hydraulic circuit, and a pressurization/depressurization device (84) configured to change the hydraulic pressure in the hydraulic circuit. Further, the control unit turns on the brake lamp when the hydraulic pressure is equal to or higher than a first threshold, and turns off the brake lamp when the hydraulic pressure is lower than the first threshold, the control unit being configured to execute a pressurization process to control the pressurization/depressurization device so as to cause the hydraulic pressure to be equal to or higher than the first threshold.

Thereby, when the vehicle is parked as a result of the stop process, the control unit causes the hydraulic pressure to be equal to or higher than the first threshold so that the brake lamp lights up.

Preferably, the brake force applying device (84) is configured to apply a brake force to a wheel of the vehicle when the hydraulic pressure in the hydraulic circuit is equal to or higher than a second threshold which is higher than the first threshold, and the control unit is configured to execute the pressurization process to control the pressurization/depressurization device so as to cause the hydraulic pressure to be equal to or higher than the first threshold and lower than the second threshold while the stop maintaining process is being executed.

Thus, by selecting the hydraulic pressure to be high enough to turn on the brake lamp, but low enough not to engage the hydraulic brake, the power consumption required to engage the hydraulic brake can be saved while the surrounding vehicles and pedestrians can be properly warned

Preferably, the vehicle control system further comprises a driving operation device (10) configured to receive an operation input from a driver, wherein the control unit maintains the hydraulic pressure to be equal to or higher than the first threshold and lower than the second threshold until an operation input is applied to the driving operation device.

Thereby, the surrounding vehicles and pedestrians are properly warned, and once the cause for the stop process is eliminated, the driver or a person taking over the driving can readily drive the vehicle to a desired destination.

Preferably, the control unit is configured to execute the pressurization process and a pressure reduction process to control the pressurization/depressurization device (83) in an intermittent manner so as to cause the hydraulic pressure to alternate between a first value equal to or higher than the first threshold, and a second value lower than the first threshold while the stop maintaining process is being executed.

By thus blinking the brake lamp when the vehicle is at a stop as a result of the stop process, the visibility of the vehicle can be enhanced for an increased safety, and the consumption of power can be reduced even further.

Preferably, the control unit is configured to execute the pressurization process and a pressure reduction process to control the pressurization/depressurization device (83) in an intermittent manner so as to cause the hydraulic pressure to alternate between a first value equal to or higher than the first threshold and lower than the second threshold, and a third value lower than the first threshold while the stop maintaining process is being executed.

By thus blinking the brake lamp when the vehicle is at a stop as a result of the stop process, the visibility of the vehicle can be enhanced for an increased safety, and the consumption of power can be reduced even further.

Preferably, the control unit is configured to shift a shift range of an automatic transmission (71) of the vehicle to a parking range before turning on the brake lamp in the stop maintain process (ST11).

Thereby, the safety of the vehicle after coming to a stop can be increased.

Preferably, the control unit is configured to shift a shift range of an automatic transmission (71) of the vehicle to a parking range, and engage a parking brake device (85) of the vehicle before turning on the brake lamp in the stop maintain process.

Thereby, the safety of the vehicle after coming to a stop can be increased.

The present invention thus provides a vehicle control system configured for autonomous driving which can keep the brake lamp turned on for a long period of time when the vehicle is parked in a stop area as a result of a stop process.

### BRIEF DESCRIPTION OF THE DRAWING(S)

FIG. 1 is a functional block diagram of a vehicle on which a vehicle control system according to the present invention is mounted;

FIG. 2 is a flowchart of a stop process;

FIG. 3 is a functional block diagram of a brake device;

FIG. 4 is a functional block diagram of a hydraulic circuit of the brake device;

FIG. 5 is a flow chart of a stop maintaining process according to a first embodiment of the present invention;

FIG. 6 is a flow chart of a stop maintaining process according to a second embodiment of the present invention; and

FIG. 7 is a flow chart of a stop maintaining process according to a third embodiment of the present invention.

### DESCRIPTION OF THE PREFERRED EMBODIMENT(S)

A vehicle control system according to a preferred embodiment of the present invention is described in the following with reference to the appended drawings. The following disclosure is according to left-hand traffic. In the case of right-hand traffic, the left and the right in the disclosure will be reversed.

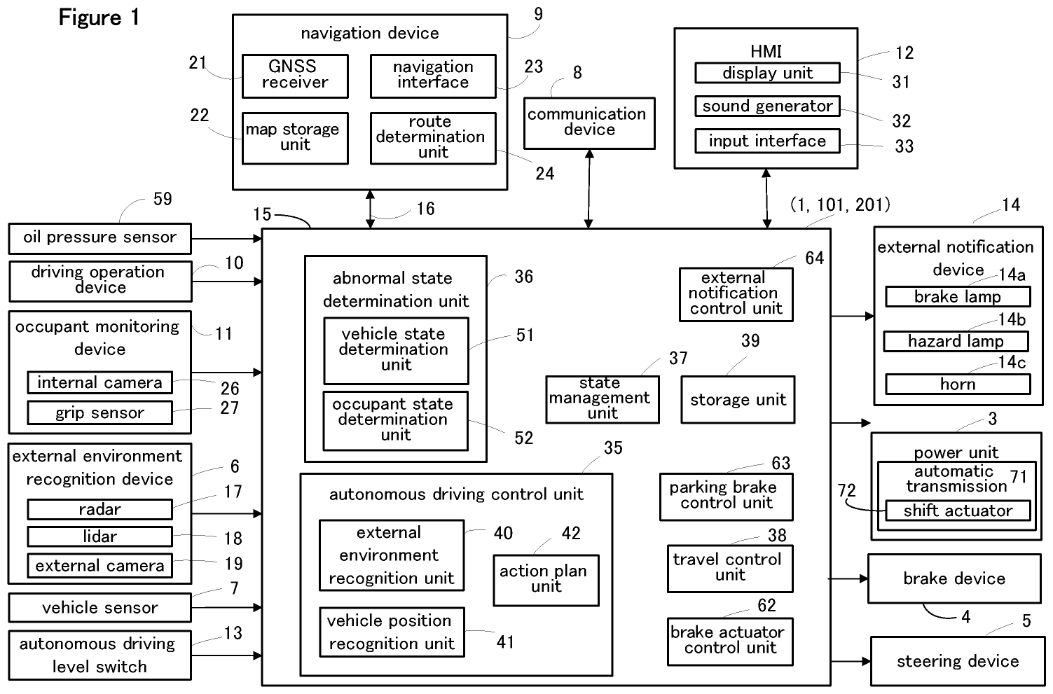

As shown in FIG. 1, the vehicle control system 1 according to the present invention is a part of a vehicle system 2 mounted on a vehicle. The vehicle system 2 includes a power unit 3, a brake device 4, a steering device 5, an external environment recognition device 6, a vehicle sensor 7, a communication device 8, a navigation device 9 (map device), a driving operation device 10, an occupant monitoring device 11, an HMI 12 (Human Machine Interface), an autonomous driving level switch 13, an external notification device 14, and a control unit 15. These components of the vehicle system 2 are connected to one another so that signals can be transmitted between them via a communication means such as CAN 16 (Controller Area Network).

The power unit 3 is a device for applying a driving force to the vehicle, and may include a power source and a transmission unit. The power source may consist of an internal combustion engine such as a gasoline engine and a diesel engine, an electric motor or a combination of these. The brake device 4 is a device that applies a brake force to the vehicle, and may include a brake caliper that presses a brake pad against a brake rotor, and an electrically actuated hydraulic cylinder that supplies hydraulic pressure to the brake caliper. The brake device 4 may also include a parking brake device. The steering device 5 is a device for changing a steering angle of the wheels, and may include a rack-and-pinion mechanism that steers the front wheels, and an electric motor that drives the rack-and-pinion mechanism. The power unit 3, the brake device 4, and the steering device 5 are controlled by the control unit 15.

The external environment recognition device 6 is a device that detects objects located outside of the vehicle. The external environment recognition device 6 may include a sensor that captures electromagnetic waves or light from around the vehicle to detect objects outside of the vehicle, and may consist of a radar 17, a lidar 18, an external camera 19, or a combination of these. The external environment recognition device 6 may also be configured to detect objects outside of the vehicle by receiving a signal from a source outside of the vehicle. The detection result of the external environment recognition device 6 is forwarded to the control unit 15.

The radar 17 emits radio waves such as millimeter waves to the surrounding area of the vehicle, and detects the position (distance and direction) of an object by capturing the reflected wave. Preferably, the radar 17 includes a front radar that radiates radio waves toward the front of the vehicle, a rear radar that radiates radio waves toward the rear of the vehicle, and a pair of side radars that radiates radio waves in the lateral directions.

The lidar 18 emits light such as an infrared ray to the surrounding part of the vehicle, and detects the position (distance and direction) of an object by capturing the reflected light. At least one lidar 18 is provided at a suitable position of the vehicle.

The external camera 19 can capture the image of the surrounding objects such as vehicles, pedestrians, guardrails, curbs, walls, median strips, road shapes, road signs, road markings painted on the road, and the like. The external camera 19 may consist of a digital camera using a solid-state imaging device such as a CCD and a CMOS. At least one external camera 19 is provided at a suitable position of the vehicle. The external camera 19 preferably includes a front camera that images the front of the vehicle, a rear camera that images the rear of the vehicle and a pair of side cameras that image the lateral views from the vehicle. The external camera 19 may consist of a stereo camera that can capture a three-dimensional image of the surrounding objects.

The vehicle sensor 7 may include a vehicle speed sensor that detects the traveling speed of the vehicle, an acceleration sensor that detects the acceleration of the vehicle, a yaw rate sensor that detects an angular velocity of the vehicle around a vertical axis, a direction sensor that detects the traveling direction of the vehicle, and the like. The yaw rate sensor may consist of a gyro sensor.

The communication device 8 allows communication between the control unit 15 which is connected to the navigation device 9 and other vehicles around the own vehicle as well as servers located outside the vehicle. The control unit 15 can perform wireless communication with the surrounding vehicles via the communication device 8. For instance, the control unit 15 can communicate with a server that provides traffic regulation information via the communication device 8, and with an emergency call center that accepts an emergency call from the vehicle also via the communication device 8. Further, the control unit 15 can communicate with a portable terminal carried by a person such as a pedestrian present outside the vehicle via the communication device 8.

The navigation device 9 is able to identify the current position of the vehicle, and performs route guidance to a destination and the like, and may include a GNSS receiver 21, a map storage unit 22, a navigation interface 23, and a route determination unit 24. The GNSS receiver 21 identifies the position (latitude and longitude) of the vehicle according to a signal received from artificial satellites (positioning satellites). The map storage unit 22 may consist of a per se known storage device such as a flash memory and a hard disk, and stores or retains map information. The navigation interface 23 receives an input of a destination or the like from the user, and provides various information to the user by visual display and/or speech. The navigation interface 23 may include a touch panel display, a speaker, and the like. In another embodiment, the GNSS receiver 21 is configured as a part of the communication device 8. The map storage unit 22 may be configured as a part of the control unit 15 or may be configured as a part of an external server that can communicate with the control unit 15 via the communication device 8.

The map information may include a wide range of road information which may include, not exclusively, road types such as expressways, toll roads, national roads, and prefectural roads, the number of lanes of the road, road markings such as the center position of each lane (three-dimensional coordinates including longitude, latitude, and height), road division lines and lane lines, the presence or absence of sidewalks, curbs, fences, etc., the locations of intersections, the locations of merging and branching points of lanes, the areas of emergency parking zones, the width of each lane, and traffic signs provided along the roads. The map information may also include traffic regulation information, address information (address/postal code), facility information, telephone number information, and the like.

The route determination unit 24 determines a route to the destination according to the position of the vehicle specified by the GNSS receiver 21, the destination input from the navigation interface 23, and the map information. When determining the route, in addition to the route, the route determination unit 24 determines the target lane which the vehicle will travel in by referring to the merging and branching points of the lanes in the map information.

The driving operation device 10 receives an input operation performed by the driver to control the vehicle. The driving operation device 10 may include a steering wheel, an accelerator pedal, and a brake pedal. Further, the driving operation device 10 may include a shift lever, a parking brake lever, and the like. Each element of the driving operation device 10 is provided with a sensor for detecting an operation amount of the corresponding operation. The driving operation device 10 outputs a signal indicating the operation amount to the control unit 15.

The occupant monitoring device 11 monitors the state of the occupant in the passenger compartment. The occupant monitoring device 11 includes, for example, an internal camera 26 that images an occupant sitting on a seat in the vehicle cabin, and a grip sensor 27 provided on the steering wheel. The internal camera 26 is a digital camera using a solid-state imaging device such as a CCD and a CMOS. The grip sensor 27 is a sensor that detects if the driver is gripping the steering wheel, and outputs the presence or absence of the grip as a detection signal. The grip sensor 27 may be formed of a capacitance sensor or a piezoelectric device provided on the steering wheel. The occupant monitoring device 11 may include a heart rate sensor provided on the steering wheel or the seat, or a seating sensor provided on the seat. In addition, the occupant monitoring device 11 may be a wearable device that is worn by the occupant, and can detect the vital information of the driver including at least one of the heart rate and the blood pressure of the driver. In this conjunction, the occupant monitoring device 11 may be configured to be able to communicate with the control unit 15 via a per se known wireless communication means. The occupant monitoring device 11 outputs the captured image and the detection signal to the control unit 15.

The external notification device 14 is a device for notifying to people outside of the vehicle by sound and/or light, and may include a warning light and a horn. A headlight (front light), a taillight, a brake lamp, a hazard lamp, and a vehicle interior light may function as a warning light.

The HMI 12 notifies the occupant of various kinds of information by visual display and speech, and receives an input operation by the occupant. The HMI 12 may include at least one of a display device 31 such as a touch panel and an indicator light including an LCD or an organic EL, a sound generator 32 such as a buzzer and a speaker, and an input interface 33 such as a GUI switch on the touch panel and a mechanical switch. The navigation interface 23 may be configured to function as the HMI 12.

The autonomous driving level switch 13 is a switch that activates autonomous driving as an instruction from the driver. The autonomous driving level switch 13 may be a mechanical switch or a GUI switch displayed on the touch panel, and is positioned in a suitable part of the cabin. The autonomous driving level switch 13 may be formed by the input interface 33 of the HMI 12 or may be formed by the navigation interface 23.

The control unit 15 may consist of an electronic control unit (ECU) including a CPU, a ROM, a RAM, and the like. The control unit 15 executes various types of vehicle control by executing arithmetic processes according to a computer program executed by the CPU. The control unit 15 may be configured as a single piece of hardware, or may be configured as a unit including a plurality of pieces of hardware. In addition, at least a part of each functional unit of the control unit 15 may be realized by hardware such as an LSI, an ASIC, and an FPGA, or may be realized by a combination of software and hardware.

The control unit 15 is configured to execute autonomous driving control of at least level 0 to level 3 by combining various types of vehicle control. The level is according to the definition of SAE J3016, and is determined in relation to the degree of machine intervention in the driving operation of the driver and in the monitoring of the surrounding environment of the vehicle.

In autonomous driving of level 0, the control unit 15 does not control the vehicle, and the driver performs all of the driving operations. Thus, autonomous driving of level 0 means a manual driving.

In autonomous driving of level 1, the control unit 15 executes a certain part of the driving operation, and the driver performs the remaining part of the driving operation. For example, autonomous driving level 1 includes constant speed traveling, inter-vehicle distance control (ACC; Adaptive Cruise Control) and lane keeping assist control (LKAS; Lane Keeping Assistance System). The level 1 autonomous driving is executed when various devices (for example, the external environment recognition device 6 and the vehicle sensor 7) required for executing the level 1 autonomous driving are all properly functioning.

In autonomous driving of level 2, the control unit 15 performs the entire driving operation. The level 2 autonomous driving is performed only when the driver monitors the surrounding environment of the vehicle, the vehicle is within a designated area, and the various devices required for performing the level 2 autonomous driving are all functioning properly.

In level 3 autonomous driving, the control unit 15 performs the entire driving operation. The level 3 autonomous driving requires the driver to monitor or be aware of the surrounding environment when required, and is executed only when the vehicle is within a designated area, and the various devices required for performing the level 3 autonomous driving are all functioning properly. The conditions under which the level 3 autonomous driving is executed may include that the vehicle is traveling on a congested road. Whether the vehicle is traveling on a congested road or not may be determined according to traffic regulation information provided from a server outside of the vehicle, or, alternatively, that the vehicle speed detected by the vehicle speed sensor is determined to be lower than a predetermined slowdown determination value (for example, 30 km/h) over a predetermined time period.

Thus, in the autonomous driving of levels 1 to 3, the control unit 15 executes at least one of the steering, the acceleration, the deceleration, and the monitoring of the surrounding environment. When in the autonomous driving mode, the control unit 15 executes the autonomous driving of level 1 to level 3. Hereinafter, the steering, acceleration, and deceleration operations are collectively referred to as driving operation, and the driving and the monitoring of the surrounding environment may be collectively referred to as driving.

In the present embodiment, when the control unit 15 has received an instruction to execute autonomous driving via the autonomous driving level switch 13, the control unit 15 selects the autonomous driving level that is suitable for the environment of the vehicle according to the detection result of the external environment recognition device 6 and the position of the vehicle acquired by the navigation device 9, and changes the autonomous driving level as required. However, the control unit 15 may also change the autonomous driving level according the input to the autonomous driving level switch 13.

As shown in FIG. 1, the control unit 15 includes an autonomous driving control unit 35, an abnormal state determination unit 36, a state management unit 37, a travel control unit 38, and a storage unit 39.

The autonomous driving control unit 35 includes an external environment recognition unit 40, a vehicle position recognition unit 41, and an action plan unit 42. The external environment recognition unit 40 recognizes an obstacle located around the vehicle, the shape of the road, the presence or absence of a sidewalk, and road signs according to the detection result of the external environment recognition device 6. The obstacles include, not exclusively, guardrails, telephone poles, surrounding vehicles, and pedestrians. The external environment recognition unit 40 can acquire the state of the surrounding vehicles, such as the position, speed, and acceleration of each surrounding vehicle from the detection result of the external environment recognition device 6. The position of each surrounding vehicle may be recognized as a representative point such as a center of gravity position or a corner positions of the surrounding vehicle, or an area represented by the contour of the surrounding vehicle.

The vehicle position recognition unit 41 recognizes a traveling lane, which is a lane in which the vehicle is traveling, and a relative position and an angle of the vehicle with respect to the traveling lane. The vehicle position recognition unit 41 may recognize the traveling lane according to the map information stored in the map storage unit 22 and the position of the vehicle acquired by the GNSS receiver 21. In addition, the lane markings drawn on the road surface around the vehicle may be extracted from the map information, and the relative position and angle of the vehicle with respect to the traveling lane may be recognized by comparing the extracted lane markings with the lane markings captured by the external camera 19.

The action plan unit 42 sequentially creates an action plan for driving the vehicle along the route. More specifically, the action plan unit 42 first determines a set of events for traveling on the target lane determined by the route determination unit 24 without the vehicle coming into contact with an obstacle. The events may include a constant speed traveling event in which the vehicle travels in the same lane at a constant speed, a preceding vehicle following event in which the vehicle follows a preceding vehicle at a certain speed which is equal to or lower than a speed selected by the driver or a speed which is determined by the prevailing environment, a lane changing event in which the vehicle change lanes, a passing event in which the vehicle passes a preceding vehicle, a merging event in which the vehicle merge into the traffic from another road at a junction of the road, a diverging event in which the vehicle travels into a selected road at a junction of the road, an autonomous driving end event in which autonomous driving is ended, and the driver takes over the driving operation, and a stop event in which the vehicle is brought to a stop when a certain condition is met, the condition including a case where the control unit 15 or the driver has become incapable of continuing the driving operation.

The conditions under which the action plan unit 42 invokes the stop event include the case where an input to the internal camera 26, the grip sensor 27, or the autonomous driving level switch 13 in response to an intervention request (a hand-over request) to the driver is not detected during autonomous driving. The intervention request is a warning to the driver to take over a part of the driving, and to perform at least one of the driving operation and the monitoring of the environment corresponding to the part of the driving that is to be handed over. The condition under which the action plan unit 42 invokes the stop even include the case where the action plan unit 42 has detected that the driver has become incapable of performing the driving while the vehicle is traveling due to a physiological ailment according to the signal from a pulse sensor, the internal camera or the like.

During the execution of these events, the action plan unit 42 may invoke an avoidance event for avoiding an obstacle or the like according to the surrounding conditions of the vehicle (existence of nearby vehicles and pedestrians, lane narrowing due to road construction, etc.).

The action plan unit 42 generates a target trajectory for the vehicle to travel in the future corresponding to the selected event. The target trajectory is obtained by sequentially arranging trajectory points that the vehicle should trace at each time point. The action plan unit 42 may generate the target trajectory according to the target speed and the target acceleration set for each event. At this time, the information on the target speed and the target acceleration is determined for each interval between the trajectory points.

The travel control unit 38 controls the power unit 3, the brake device 4, and the steering device 5 so that the vehicle traces the target trajectory generated by the action plan unit 42 according to the schedule also generated by the action plan unit 42.

The storage unit 39 is formed by a ROM, a RAM, or the like, and stores information required for the processing by the autonomous driving control unit 35, the abnormal state determination unit 36, the state management unit 37, and the travel control unit 38.

The abnormal state determination unit 36 includes a vehicle state determination unit 51 and an occupant state determination unit 52. The vehicle state determination unit 51 analyzes signals from various devices (for example, the external environment recognition device 6 and the vehicle sensor 7) that affect the level of the autonomous driving that is being executed, and detects the occurrence of an abnormality in any of the devices and units that may prevent a proper execution of the autonomous driving of the level that is being executed.

The occupant state determination unit 52 determines if the driver is in an abnormal state or not according to a signal from the occupant monitoring device 11. The abnormal state includes the case where the driver is unable to properly steer the vehicle in autonomous driving of level 1 or lower that requires the driver to steer the vehicle. That the driver is unable to steer the vehicle in autonomous driving of level 1 or lower could mean that the driver is not holding the steering wheel, the driver is asleep, the driver is incapacitated or unconscious due to illness or injury, or the driver is under a cardiac arrest. The occupant state determination unit 52 determines that the driver is in an abnormal state when there is no input to the grip sensor 27 from the driver while in autonomous driving of level 1 or lower that requires the driver to steer the vehicle. Further, the occupant state determination unit 52 may determine the open/closed state of the driver's eyelids from the face image of the driver that is extracted from the output of the internal camera 26. The occupant state determination unit 52 may determine that the driver is asleep, under a strong drowsiness, unconscious or under a cardiac arrest so that the drive is unable to properly drive the vehicle, and the driver is in an abnormal condition when the driver's eyelids are closed for more than a predetermined time period, or when the number of times the eyelids are closed per unit time interval is equal to or greater than a predetermined threshold value. The occupant state determination unit 52 may further acquire the driver's posture from the captured image to determine that the driver's posture is not suitable for the driving operation or that the posture of the driver does not change for a predetermined time period. It may well mean that the driver is incapacitated due to illness or injury, and in an abnormal condition.

In the case of autonomous driving of level 2 or lower, the abnormal condition includes a situation where the driver is neglecting the duty to monitor the environment surrounding the vehicle. This situation may include either the case where the driver is not holding or gripping the steering wheel or the case where the driver's line of sight is not directed in the forward direction. The occupant state determination unit 52 may detect the abnormal condition where the driver is neglecting to monitor the environment surrounding the vehicle when the output signal of the grip sensor 27 indicates that the driver is not holding the steering wheel. The occupant state determination unit 52 may detect the abnormal condition according to the image captured by the internal camera 26. The occupant state determination unit 52 may use a per se known image analysis technique to extract the face region of the driver from the captured image, and then extracts the iris parts (hereinafter, iris) including the inner and outer corners of the eyes and pupils from the extracted face area. The occupant state determination unit 52 may detect the driver's line of sight according to the positions of the inner and outer corners of the eyes, the iris, the outline of the iris, and the like. It is determined that the driver is neglecting the duty to monitor the environment surrounding the vehicle when the driver's line of sight is not directed in the forward direction.

In addition, in the autonomous driving at a level where the drive is not required to monitor the surrounding environment or in the autonomous driving of level 3, an abnormal condition refers to a state in which the driver cannot promptly take over the driving when a driving takeover request is issued to the driver. The state where the driver cannot take over the driving includes the state where the system cannot be monitored, or, in other words, where the driver cannot monitor a screen display that may be showing an alarm display such as when the driver is asleep, and when the driver is not looking ahead. In the present embodiment, in the level 3 autonomous driving, the abnormal condition includes a case where the driver cannot perform the duty of monitoring the surrounding environment of the vehicle even though the driver is notified to monitor the surrounding environment of the vehicle. In the present embodiment, the occupant state determination unit 52 displays a predetermined screen on the display device 31 of the HMI 12, and instructs the driver to look at the display device 31. Thereafter, the occupant state determination unit 52 detects the driver's line of sight with the internal camera 26, and determines that the driver is unable to fulfill the duty of monitoring the surrounding environment of the vehicle if driver's line of sight is not facing the display device 31 of the HMI 12.

The occupant state determination unit 52 may detect if the driver is gripping the steering wheel according to the signal from the grip sensor 27, and if the driver is not gripping the steering wheel, it can be determined that the vehicle is in an abnormal state in which the duty of monitoring the surrounding environment the vehicle is being neglected. Further, the occupant state determination unit 52 determines if the driver is in an abnormal state according to the image captured by the internal camera 26. For example, the occupant state determination unit 52 extracts a driver's face region from the captured image by using a per se known image analysis means. The occupant state determination unit 52 may further extract iris parts (hereinafter, iris) of the driver including the inner and outer corners of the eyes and pupils from the extracted face area. The occupant state determination unit 52 obtains the driver's line of sight according to the extracted positions of the inner and outer corners of the eyes, the iris, the outline of the iris, and the like. It is determined that the driver is neglecting the duty to monitor the environment surrounding the vehicle when the driver's line of sight is not directed in the forward direction.

The state management unit 37 selects the level of the autonomous driving according to at least one of the own vehicle position, the operation of the autonomous driving level switch 13, and the determination result of the abnormal state determination unit 36. Further, the state management unit 37 controls the action plan unit 42 according to the selected autonomous driving level, thereby performing the autonomous driving according to the selected autonomous driving level. For example, when the state management unit 37 has selected the level 1 autonomous driving, and a constant speed traveling control is being executed, the event to be determined by the action plan unit 42 is limited only to the constant speed traveling event.

The state management unit 37 raises and lowers the autonomous driving level as required in addition to executing the autonomous driving according to the selected level.

More specifically, the state management unit 37 raises the level when the condition for executing the autonomous driving at the selected level is met, and an instruction to raise the level of the autonomous driving is input to the autonomous driving level switch 13.

When the condition for executing the autonomous driving of the current level ceases to be satisfied, or when an instruction to lower the level of the autonomous driving is input to the autonomous driving level switch 13, the state management unit 37 executes an intervention request process. In the intervention request process, the state management unit 37 first notifies the driver of a handover request. The notification to the driver may be made by displaying a message or image on the display device 31 or generating a speech or an acoustic notification from the sound generator 32. The notification to the driver may continue for a predetermined period of time after the intervention request process is started or may be continued until an input is detected by the occupant monitoring device 11.

The condition for executing the autonomous driving of the current level ceases to be satisfied when the vehicle has moved to an area where only the autonomous driving of a level lower than the current level is permitted, or when the abnormal state determination unit 36 has determined that an abnormal condition that prevents the continuation of the autonomous driving of the current level has occurred to the driver or the vehicle.

Following the notification to the driver, the state management unit 37 detects if the internal camera 26 or the grip sensor 27 has received an input from the driver indicating a takeover of the driving. The detection of the presence or absence of an input to take over the driving is determined in a way that depends on the level that is to be selected. When moving to level 2, the state management unit 37 extracts the driver's line of sight from the image acquired by the internal camera 26, and when the driver's line of sight is facing the front of the vehicle, it is determined that an input indicating the takeover of the driving by the driver is received. When moving to level 1 or level 0, the state management unit 37 determines that there is an input indicating an intent to take over the driving when the grip sensor 27 has detected the gripping of the steering wheel by the driver. Thus, the internal camera 26 and the grip sensor 27 function as an intervention detection device that detects an intervention of the driver to the driving. Further, the state management unit 37 may detect if there is an input indicating an intervention of the driver to the driving according to the input to the autonomous driving level switch 13.

The state management unit 37 lowers the autonomous driving level when an input indicating an intervention to the driving is detected within a predetermined period of time from the start of the intervention request process. At this time, the level of the autonomous driving after the lowering of the level may be level 0, or may be the highest level that can be executed.

The state management unit 37 causes the action plan unit 42 to generate a stop event when an input corresponding to the driver's intervention to the driving is not detected within a predetermined period of time after the execution of the intervention request process. The stop event is an event in which the vehicle is brought to a stop at a safe position (for example, an emergency parking zone, a roadside zone, a roadside shoulder, a parking area, etc.) while the vehicle control is degenerated. Here, a series of procedures executed in the stop event may be referred to as MRM (Minimum Risk Maneuver).

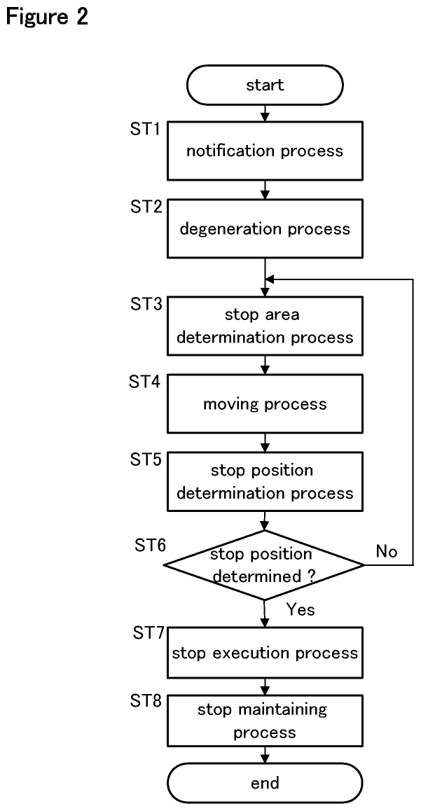

When the stop event is invoked, the control unit 15 shifts from the autonomous driving mode to the autonomous stopping mode, and the action plan unit 42 executes the stop process. Hereinafter, an outline of the stop process is described with reference to the flowchart of FIG. 2.

In the stop process, a notification process is first executed (step ST1). In the notification process, the action plan unit 42 operates the external notification device 14 to notify the people outside of the vehicle. For example, the action plan unit 42 activates a horn included in the external notification device 14 to periodically generate an acoustic notification. The notification process continues until the stop process ends. After the notification process has ended, the action plan unit 42 may continue to activate the horn to generate an acoustic notification depending on the situation.

Then, a degeneration process is executed (step ST2). The degeneration process is a process of restricting events that can be invoked by the action plan unit 42. The degeneration process may prohibit a lane change event to a passing lane, a passing event, a merging event, and the like. Further, in the degeneration process, the speed upper limit and the acceleration upper limit of the vehicle may be more limited in the respective events as compared with the case where the stop process is not performed.

Next, a stop area determination process is executed (step ST3). The stop area determination process refers to the map information according to the current position of the own vehicle, and extracts a plurality of available stop areas (candidates for the stop area or potential stop areas) suitable for stopping, such as road shoulders and evacuation spaces in the traveling direction of the own vehicle. Then, one of the available stop areas is selected as the stop area by taking into account the size of the stop area, the distance to the stop area, and the like.

Next, a moving process is executed (step ST4). In the moving process, a route for reaching the stop area is determined, various events along the route leading to the stop area are generated, and a target trajectory is determined. The travel control unit 38 controls the power unit 3, the brake device 4, and the steering device 5 according to the target trajectory determined by the action plan unit 42. The vehicle then travels along the route and reaches the stop area.

Next, a stop position determination process is executed (step ST5). In the stop position determination process, the stop position is determined according to obstacles, road markings, and other objects located around the vehicle recognized by the external environment recognition unit 40. In the stop position determination process, it is possible that the stop position cannot be determined in the stop area due to the presence of surrounding vehicles and obstacles. When the stop position cannot be determined in the stop position determination process (No in step ST6), the stop area determination process (step ST3), the movement process (step ST4), and the stop position determination process (step ST5) are sequentially repeated.

If the stop position can be determined in the stop position determination process (Yes in step ST6), a stop execution process is executed (step ST7). In the stop execution process, the action plan unit 42 generates a target trajectory according to the current position of the vehicle and the targeted stop position. The travel control unit 38 controls the power unit 3, the brake device 4, and the steering device 5 according to the target trajectory determined by the action plan unit 42. The vehicle then moves toward the stop position and stops at the stop position.

After the stop execution process is executed, a stop maintaining process is executed (step ST8). In the stop maintaining process, the travel control unit 38 drives the parking brake device according to a command from the action plan unit 42 to maintain the vehicle at the stop position. Thereafter, the action plan unit 42 may transmit an emergency call to the emergency call center by the communication device 8. When the stop maintaining process is completed, the stop process ends.

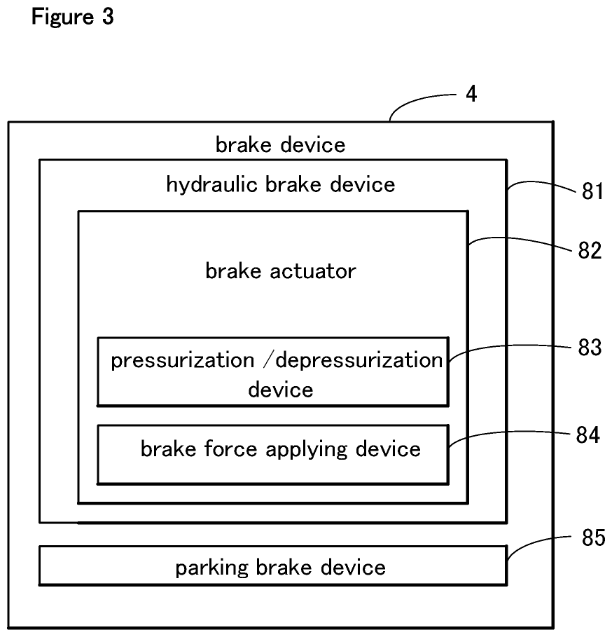

The vehicle control system 1 is provided with the brake device 4, the power unit 3, the external notification device 14, the control unit 15, and the driving operation device 10 as discussed earlier. In this embodiment, as shown in FIGS. 1 and 3, the vehicle control system 1 includes a brake lamp 14a as a part of the external notification device 14, and turns on the brake lamp 14a after the vehicle has come to a stop until the stop process is ended. For this purpose, the vehicle control system 1 is provided with an oil pressure sensor 59 that detects the oil pressure applied to the brake device 4.

The brake device 4 includes a hydraulic brake device 81 and a parking brake device 85. The hydraulic brake device 81 includes a brake actuator 82 that converts an input from the control unit 15 or the driving operation device 10 (a brake pedal 89) into a hydraulic pressure and applies a brake force according to the hydraulic pressure value to the wheels. The control unit 15 further includes a brake actuator control unit 62 that controls the brake actuator 82 and a parking brake control unit 63 that controls the parking brake device 85. The control unit 15 turns on the brake lamp 14a according to the hydraulic pressure detected by the oil pressure sensor 59.

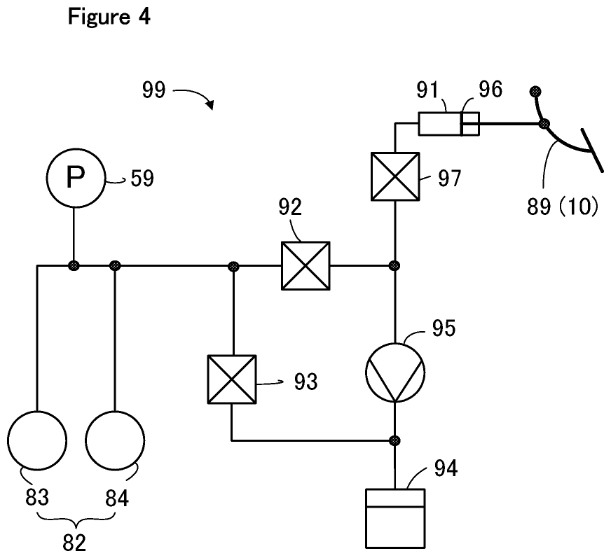

As shown in FIGS. 3 and 4, the brake actuator 82 includes a brake force applying device 84 that actuates the brake caliper so as to press a brake pad against a brake disk of each wheel, and a pressurizing/depressurizing device 83. The pressurizing/depressurizing device 83 includes a master cylinder 91, a retaining solenoid valve 92, a pressure reducing solenoid valve 93, a reservoir tank 94, and a pump 95. The master cylinder 91, the retaining solenoid valve 92, the pressure reducing solenoid valve 93, the brake force applying device 84, and the pump 95 are connected by piping which is filled with brake oil to form a hydraulic circuit 99. Thus, the brake device 4 includes the hydraulic circuit 99, the brake force applying device 84, and the pressurizing/depressurizing device 83.

As shown in FIG. 4, the master cylinder 91 is provided with a piston 96, and the piston 96 is connected to the brake pedal 89. When the driver depresses the brake pedal 89, the piston 96 in the master cylinder 91 moves so that a pressure is generated in the master cylinder 91, and is applied to a brake actuator 82 of the brake caliper.

The brake force applying device 84 is connected to the master cylinder 91 via a part of the piping which is provided with a cut valve 97.

The retaining solenoid valve 92 is provided in a part of the piping connecting the brake force applying device 84 with the cut valve 97. Thus, the brake force applying device 84 and the master cylinder 91 are connected to each other via the cut valve 97 and the retaining solenoid valve 92.

The pressure reducing solenoid valve 93 is provided between the reservoir tank 94 and a part of the piping connecting the brake force applying device 84 with the retaining solenoid valve 92. Thus, the brake force applying device 84 and the reservoir tank 94 are connected to each other via the pressure reducing solenoid valve 93.

The pump 95 is provided between the reservoir tank 94 and a part of the piping connecting the retaining solenoid valve 92 with the cut valve 97. The pump 95 circulates the brake oil in the reservoir tank 94 to the part of the piping connecting the retaining solenoid valve 92 with the cut valve 97. The pump 95 is provided with a check valve so that the brake oil is prevented from flowing backward from the part of the piping connecting the pressure reducing solenoid valve 93 with the reservoir tank 94 to the part of the piping connecting the cut valve 97 with the retaining solenoid valve 92.

The oil pressure sensor 59 is provided in a part of the piping connecting brake force applying device 84 with the retaining solenoid valve 92, and detects a hydraulic pressure of the oil in a part of the piping connecting the brake force applying device 84 with the retaining solenoid valve 92. The oil pressure sensor 59 forwards the detected oil pressure value to the control unit 15.

The brake actuator control unit 62 controls the retaining solenoid valve 92, the pressure reducing solenoid valve 93, and the pump 95 according to the signal from the oil pressure sensor 59, and adjusts the oil pressure value in the part of the piping connecting the retaining solenoid valve 92 with the brake force applying device 84. In the present embodiment, the brake actuator 82 can set the oil pressure value in the part of the piping connecting the retaining solenoid valve 92 with the brake force applying device 84 to the oil pressure value commanded by the action plan unit 42. The action plan unit 42 in particular turns on the brake lamp 14a via the external notification control unit 64 when the oil pressure value is equal to or higher than a first threshold as will be discussed hereinafter.

For example, when the brake actuator control unit 62 opens the cut valve 97 and the retaining solenoid valve 92 and closes the pressure reducing solenoid valve 93, the connection between the master cylinder 91 and the brake force applying device 84 is established while the connection between the reservoir tank 94 and the piping between the master cylinder 91 and the brake force applying device 84 is cut. When the driver steps on the brake pedal 89, the piston 96 is pushed into the master cylinder 91, and the hydraulic pressure in the master cylinder 91 increases. The hydraulic pressure produced in the master cylinder 91 is transmitted to the brake force applying device 84. As a result, the brake pad is pressed against the brake disk in each of the wheels, and a brake force is applied to the wheels. Further, when the oil pressure in the piping connecting the brake force applying device 84 with the retaining solenoid valve 92 becomes equal to or higher than an oil pressure threshold (first threshold), the brake lamp 14a is turned on.

Similarly, when the brake actuator control unit 62 closes the cut valve 97, opens the retaining solenoid valve 92, closes the pressure reducing solenoid valve 93, and drives the pump 95, the oil in the piping connecting the brake force applying device 84 with the cut valve 97 is pressurized by the pump 95. As a result, the brake pad is pressed against the brake disk in each of the wheels, and a brake force is applied to the wheels. Further, when the oil pressure in the piping connecting the brake force applying device 84 with the retaining solenoid valve 92 becomes equal to or higher than the oil pressure threshold (first threshold), the brake lamp 14a is turned on.

When the brake actuator control unit 62 closes the cut valve 97, closes the retaining solenoid valve 92, and opens the pressure reducing solenoid valve 93, the oil in the piping between the retaining solenoid valve 92 and the brake force applying device 84 flows into the reservoir tank 94, and the oil in the piping between the retaining solenoid valve 92 and the brake force applying device 84 is depressurized. When the pressure in the piping between the retaining solenoid valve 92 and brake force applying device 84 becomes lower than the oil pressure threshold (first threshold), the brake lamp 14a turns off.

As shown in FIG. 1, the power unit 3 includes an automatic transmission 71. The automatic transmission 71 may be a continuously variable transmission or a step-wise automatic transmission. In either case, the automatic transmission 71 is provided with a shift actuator 72. The shift actuator 72, either manually or under command from the control unit 15, selects a shift position from a drive range (D range), a neutral range (N range), a parking range (P range), and a reverse range (R range). In particular, the action plan unit 42 switches the shift range according to the manual operation of the driver during manual driving, and automatically transmits a signal to the automatic transmission 71 to change the shift range as required in autonomous driving.

The parking brake device 85 is a device for frictionally holding the wheels when the vehicle is at a stop. In the present embodiment, the parking brake device 85 holds the rear wheels by pressing a brake pad on a brake drum provided on each rear wheel. The parking brake device 85 may be manually engaged by the driver, and may also be engaged under the command from the parking brake control unit 63. For example, when there is an input from the driver to the parking switch during manual driving, the action plan unit 42 drives the parking brake device 85 to hold the rear wheels. In autonomous driving, the action plan unit 42 drives the parking brake device 85 as needed to hold the rear wheels.

The external notification device 14 is a device that notifies the outside of the vehicle by light and/or sound. The external notification device 14 includes a hazard lamp 14b, and a horn 14c in addition to the brake lamp 14a. The control unit 15 further includes an external notification control unit 64 that controls the external notification device 14. The external notification control unit 64 performs the notification via the external notification device 14 by controlling the voltage applied to the external notification device 14 according to the signal from the action plan unit 42. The notification by the hazard lamp 14b and the horn 14c may be continuously performed before the vehicle comes to a stop in the stop process (typically as soon as the stop process is initiated).

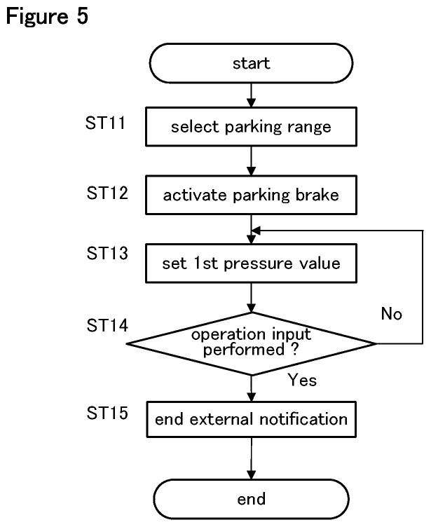

With reference to FIG. 5, details of the stop maintaining process executed by the action plan unit 42 to turn on the brake lamp 14a even after the vehicle has come to a stop will be described.

In the first step ST11 of the stop maintaining process, the action plan unit 42 drives the shift actuator 72 to set the shift range of the automatic transmission 71 to the parking range. After the shift range of the automatic transmission 71 is set to the parking range, the action plan unit 42 executes step ST12.

In step ST12, the action plan unit 42 transmits a signal instructing the parking brake control unit 63 to engage the parking brake. When the transmission of the signal is completed, the action plan unit 42 executes step ST13.

In step ST13, the action plan unit 42 commands the brake actuator control unit 62 to control the brake actuator 82 so that the oil pressure value acquired by the oil pressure sensor 59 becomes a first oil pressure value (pressurization process). When the hydraulic pressure value acquired by the oil pressure sensor 59 becomes the first hydraulic pressure value, the action plan unit 42 executes step ST14. The first oil pressure value is set to a predetermined value equal to or higher than an oil pressure threshold. In the present embodiment, the first oil pressure value is equal to the oil pressure threshold.

In step ST14, the action plan unit 42 executes step ST13 when it is determined that there is no prescribed input to the driving operation device 10, and executes step ST15 when there is a prescribed input to the driving operation device 10.

In step ST15, the action plan unit 42 transmits a signal commanding the external notification control unit 64 to end the notification by the external notification device 14. When the transmission of the signal is completed, the action plan unit 42 ends the stop maintaining process.

The mode of operation of the thus configured vehicle control system 1 is discussed in the following.

In the vehicle control system 1 according to the present embodiment, after the vehicle has come to a stop in the stop process, the action plan unit 42 executes the stop maintaining process. At this time, the action plan unit 42 first sets the shift range of the automatic transmission 71 to the parking range (ST11), and engages the parking brake device 85 (ST12). Thereafter, the action plan unit 42 drives the brake actuator 82 to perform a pressurization process, and sets a hydraulic pressure value applied to the brake force applying device 84 to the first hydraulic pressure value (ST13). As a result, a brake force is applied to the wheels by the brake force applying device 84, and the brake lamp 14a is turned on. Thereafter, the hydraulic pressure value is maintained at the first hydraulic pressure value until a prescribed operation input is applied to the driving operation device 10 (ST14). When a driving operation input is received, the action plan unit 42 ends the notification by the external notification device 14 (ST15).

The advantages of the vehicle control system 1 of this embodiment are discussed in the following. The brake lamp 14a is not turned on by engaging the parking brake device 85. Therefore, if only the parking brake device 85 is engaged when the vehicle is parked in an emergency situation, the brake lamp 14a is not turned on, and the surrounding vehicles and pedestrians may not be appropriately warned of the emergency situation or the presence of the parked vehicle.

In this embodiment, even when the vehicle is at a stop, and the parking brake device 85 is operated (while the hydraulic brake device 81 is not engaged), the brake oil in the piping of the hydraulic circuit 99 is pressurized such that the oil pressure value becomes equal to or higher than the first oil pressure threshold. As a result, the brake lamp 14a is turned on so that the surrounding vehicles and pedestrians are enabled to readily recognize that the vehicle is parked. This allows the other vehicles approaching the parked vehicle to avoid the parked vehicle, and/or allows the occupants of other vehicles and pedestrian to become aware of the emergency situation.

The brake oil in the hydraulic circuit 99 is pressurized by the pump 95. At this time, driving of the pump 95 consumes power of the battery mounted on the vehicle. In the present embodiment, the oil pressure in the piping is maintained is equal to or higher than the first threshold so that the brake lamp 14a is turned on, but is lower than a second threshold so that the hydraulic brake device 81 is not engaged, and the consumption of power by the pump 95 is relatively low. Thus, the brake oil is not pressurized by the pump 95 more than necessary to light the brake lamp 14a so that the power consumption by the pump 95 is reduced. As a result, the power consumption of the battery required for lighting the brake lamp 14a is reduced, and after the vehicle has come to a stop, the brake lamp 14a can be kept turned on for a long period of time to notify the outside of the vehicle that the vehicle is kept parked under an emergency situation.

### Second Embodiment

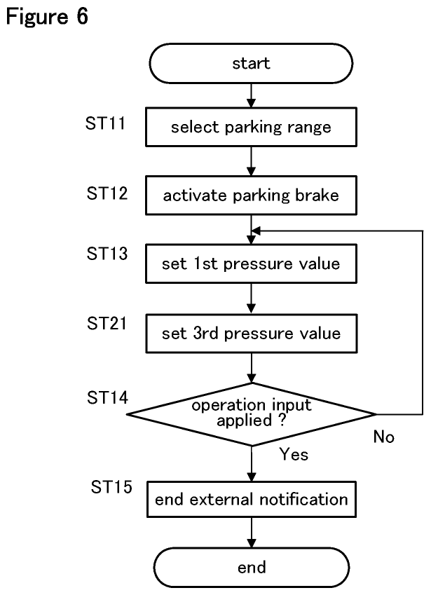

A vehicle control system 101 according to a second embodiment of the present invention is described in the following with reference to FIG. 6. The vehicle control system 101 of the second embodiment is different from the vehicle control system 1 of the first embodiment in that step ST21 is performed between step ST13 and step ST14 shown in FIG. 5. The second embodiment is otherwise similar to the first embodiment. Therefore, only step ST21 is described in detail, and the remaining part of the vehicle control system 101 is omitted from the following description. In the following description, the parts common to the first embodiment are denoted by the same reference numerals.

In step ST21, the action plan unit 42 drives the brake actuator 82, and controls the brake actuator 82 so that the oil pressure value acquired by the oil pressure sensor 59 becomes a third oil pressure value (pressure reduction process). The third oil pressure value is lower than the first oil pressure value, and is therefore lower than the threshold value at which the brake lamp 14a is turned on. When the hydraulic pressure value acquired by the oil pressure sensor 59 becomes the third hydraulic pressure value, the action plan unit 42 executes step ST14.

The mode of operation and advantages of the vehicle control system 101 of the second embodiment are discussed in the following.

In the stop process, once the vehicle comes to a stop, the action plan unit 42 executes the stop maintaining processing. At this time, similarly to the first embodiment, the action plan unit 42 executes the pressurization process (ST13) and turns on the brake lamp 14a. Thereafter, the action plan unit 42 performs a pressure reduction process for setting the oil pressure value acquired by the oil pressure sensor 59 to be lower than the first threshold (ST21). As a result, the oil pressure value becomes lower than the first threshold value for turning on the brake lamp 14a, and the brake lamp 14a is turned off.

Further, in the present embodiment, the pressurizing process and the depressurizing process are repeatedly executed until a prescribed operation input is applied to the driving operation device 10. As a result, the brake lamp 14a blinks. This makes it easier for the surrounding vehicles and pedestrians to recognized that the vehicle in an emergency situation is parked, as compared to the case where the brake lamp 14a is kept turned off or kept turned on, so that the safety of the vehicle is further enhanced.

In addition, as compared to the case where the pressurizing process is continuously performed as in the first embodiment, the power consumption of the pump 95 can be further reduced. Therefore, the brake lamp 14a can be kept blinking for a long period of the time for the given capacity of the onboard battery.

### Third Embodiment

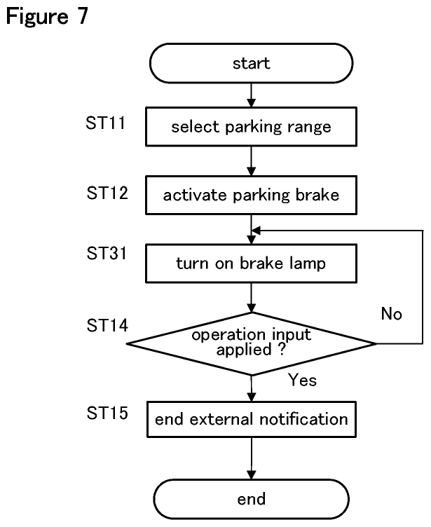

A vehicle control system 201 according to a third embodiment of the present invention is described in the following with reference to FIG. 7. The vehicle control system 201 of the third embodiment differs from the vehicle control system 1 of the first embodiment in that the action plan unit 42 executes step ST31 in the stop maintaining process, instead of step ST13 shown in FIG. 5. In step ST31, the control unit 15 commands the external notification control unit 64 to turn on the brake lamp 14a. The third embodiment is otherwise similar to the first embodiment. Hereinafter, only step ST31 is described in detail, and the remaining part of the vehicle control system 201 is omitted from the following description. In the following description, the parts common to the first embodiment are denoted by the same reference numerals.

In step ST31, the action plan unit 42 transmits a signal to command to the external notification control unit 64 to turn on the brake lamp 14a. In this case, the brake lamp 14a is turned on without regard to the hydraulic pressure in the hydraulic circuit. When the transmission of the signal is completed, the action plan unit 42 executes step ST14.

The mode of operation and the advantages of the vehicle control system 201 of the third embodiment are discussed in the following.

When the vehicle has come to a stop in the stop process, the action plan unit 42 executes the stop maintaining process. After engaging the parking brake device 85, the action plan unit 42 commands the external notification control unit 64 to turn on the brake lamp 14a. As a result, the brake lamp 14a is turned on and kept turned on regardless of the oil pressure value. The brake lamp 14a can be turned on without requiring to driving the pump 95 or pressurizing the hydraulic circuit as opposed to the first and second embodiments so that the overall structure can be simplified, and energy consumption can be minimized even further.

The present invention has been described in terms of specific embodiments, but is not limited by such embodiment, but can be modified in various ways without departing from the scope of the present invention. In the foregoing embodiments, the control of the hydraulic pressure (the pressurizing process and the depressurizing process) is performed until the driver's operation input is received, but the present invention is not limited to this mode. For example, the vehicle sensor may include a sensor that detects the opening and closing of the door in the vehicle, and the action plan unit 42 may end the control of the hydraulic pressure upon detecting that the door is opened according to the detection result of the sensor.

Also, in the foregoing embodiments, the vehicle control system (1, 101, 201) had a hydraulic circuit for actuating the hydraulic brake device 81, but the present invention is not limited to this mode. For example, the brake device 4 may be provided with an electrically actuated brake device, and the control unit 15 may be configured to turn on the brake lamp 14a when the electrically actuated brake device is engaged.

1. A vehicle control system configured for autonomous driving, comprising:
a control unit for steering, accelerating, and decelerating a vehicle;
a brake device for applying a brake force to the vehicle; and
a brake lamp;
wherein the control unit is configured to execute a stop process by which the vehicle is parked in a prescribed stop area when it is detected that the control unit or a driver has become incapable of properly maintaining a traveling state of the vehicle, and a stop maintaining process for keeping the vehicle parked following the vehicle coming to a stop in the stop process, the control unit keeping the brake lamp turned on while the stop maintaining process is being executed.

2. The vehicle control system according to claim 1, wherein the brake device includes a hydraulic circuit, a brake force applying device for applying a brake force to a wheel of the vehicle in response to a hydraulic pressure in the hydraulic circuit, and a pressurization/depressurization device configured to change the hydraulic pressure in the hydraulic circuit, and
wherein the control unit turns on the brake lamp when the hydraulic pressure is equal to or higher than a first threshold, and turns off the brake lamp when the hydraulic pressure is lower than the first threshold, the control unit being configured to execute a pressurization process to control the pressurization/depressurization device so as to cause the hydraulic pressure to be equal to or higher than the first threshold while the stop maintain process is being executed.

3. The vehicle control system according to claim 2, wherein the brake force applying device is configured to apply a brake force to a wheel of the vehicle when the hydraulic pressure in the hydraulic circuit is equal to or higher than a second threshold which is higher than the first threshold, and the control unit is configured to execute the pressurization process to control the pressurization/depressurization device so as to cause the hydraulic pressure to be equal to or higher than the first threshold and lower than the second threshold while the stop maintaining process is being executed.

4. The vehicle control system according to claim 3, further comprising a driving operation device configured to receive an operation input from a driver, wherein the control unit maintains the hydraulic pressure to be equal to or higher than the first threshold and lower than the second threshold until an operation input is applied to the driving operation device.

5. The vehicle control system according to claim 2, wherein the control unit is configured to execute the pressurization process and a pressure reduction process to control the pressurization/depressurization device in an intermittent manner so as to cause the hydraulic pressure to alternate between a first value equal to or higher than the first threshold, and a second value lower than the first threshold while the stop maintaining process is being executed.

6. The vehicle control system according to claim 2, wherein the control unit is configured to execute the pressurization process and a pressure reduction process to control the pressurization/depressurization device in an intermittent manner so as to cause the hydraulic pressure to alternate between a first value equal to or higher than the first threshold and lower than a second threshold, and a third value lower than the first threshold while the stop maintaining process is being executed.

7. The vehicle control system according to claim 2, wherein the control unit is configured to shift a shift range of an automatic transmission of the vehicle to a parking range before turning on the brake lamp when the vehicle is brought to a stop in the stop process.

8. The vehicle control system according to claim 2, wherein the control unit is configured to shift a shift range of an automatic transmission device of the vehicle to a parking range, and engage a parking brake device of the vehicle before turning on the brake lamp when the vehicle is brought to a stop in the stop maintain process.
